(19) United States
(12) Patent Application Publication
(10) Pub. No.: US 2016/0010043 A9
(43) Pub. Date: Jan. 14, 2016

(54) Alcohol Evaporation Consumption Device

(71) Applicant: Julie G. Palmer, Chicago, IL (US)

(72) Inventor: Julie G. Palmer, Chicago, IL (US)

(73) Assignee: 37 Investment, LLC, Chicago, IL (US)

(21) Appl. No.: 14/059,525

(22) Filed: Oct. 22, 2013

Related U.S. Application Data
(60) Provisional application No. 61/850,260, filed on Feb. 12, 2013.

(51) Int. Cl. C12G 3/00; B01B 1/00

(52) U.S. Cl. CPC C12G 3/00; B01B 1/005

(57) ABSTRACT

An apparatus and method for permitting consumption of alcohol vapors is disclosed. The apparatus comprises a heating chamber, a vessel disposed above the heating chamber, the vessel including an aperture, the aperture adapted to receive alcohol in liquid form to be placed in the vessel an to receive a straw and a heating element disposed in the heating chamber the heating element heats the liquid alcohol in the vessel, converting the liquid into a vapor to be inhaled via the straw.

### FIELD OF THE INVENTION

The present invention is invention relates to device for evaporating an alcoholic beverage to create alcohol vapors for consumption, such as by a human.

### BACKGROUND

In the history of human consumption of an alcoholic beverage, the alcoholic beverage has typically been consumed by drinking the alcoholic beverage.

In accordance with the present invention, an apparatus and method is provided which permits consumption of an alcoholic beverage by heating the alcoholic beverage, generating alcoholic vapors and inhaling the generated vapors.

The generation of the alcoholic vapors creates a product that is low in calories, carbohydrates and impurities that are in many liquor-based beverages. The practice of inhaling alcohol vapors ma also eliminate stomach irritation that can be caused from the traditional consumption of honor in liquid form.

Alcohol consumed in this way may also be a more effective way to moderate consumption and not over imbibe. The alcohol vapor that is inhaled is absorbed by the bloodstream almost immediately, unlike drinking liquor which takes time to be absorbed and therefore the effects are delayed.

There are practices that involve pouring liquor over a heating element of a sauna and inhaling the evaporated alcohol. This is not practical for most people because of the rarity of personal saunas and it's limitation to consumption in a specific place where the sauna is located.

This present invention permits a similar experience in a more convenient way.

### SUMMARY

One object or the present invention is to provide a method and apparatus to consume alcohol by inhaling the vapors of liquor that has been heated. This may be accomplished by heating a vessel that contains liquor in liquid form, thereby evaporating the liquid to generate an alcoholic vapor; and inhaling the alcoholic vapor, such as through a straw inserted inside of the vessel.

### BRIEF DESCRIPTION OF THE DRAWING

FIG. 1 is a side view of one embodiment of an alcohol evaporation consumption device in accordance with the present invention;

FIG. 2 is a top view of the vessel of FIG. 1; and

FIG. 3 is a top view of the ring of FIG. 1

### DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

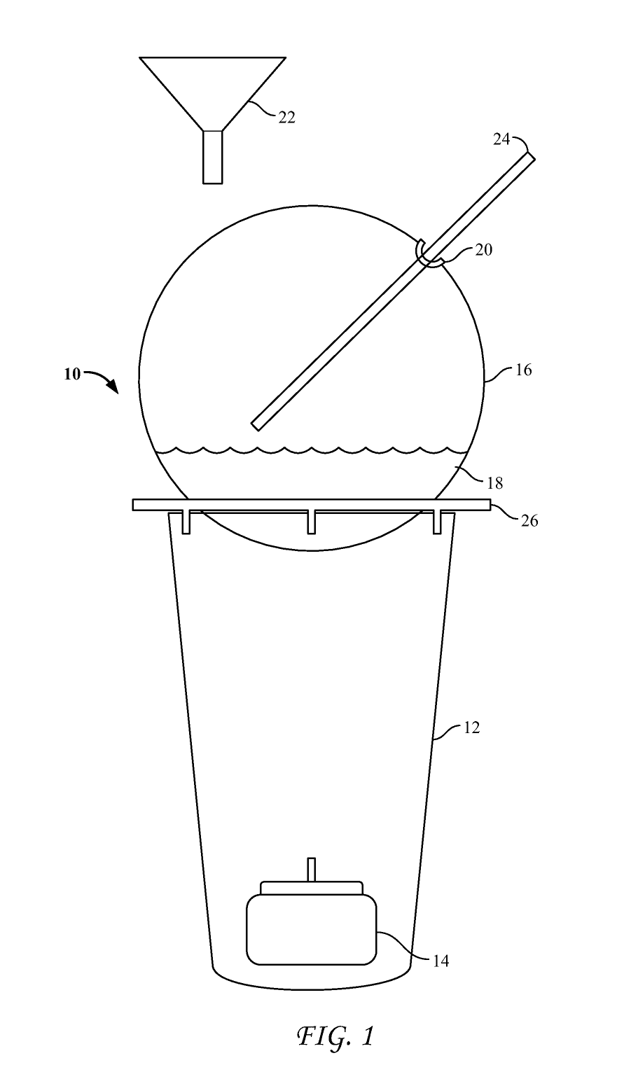

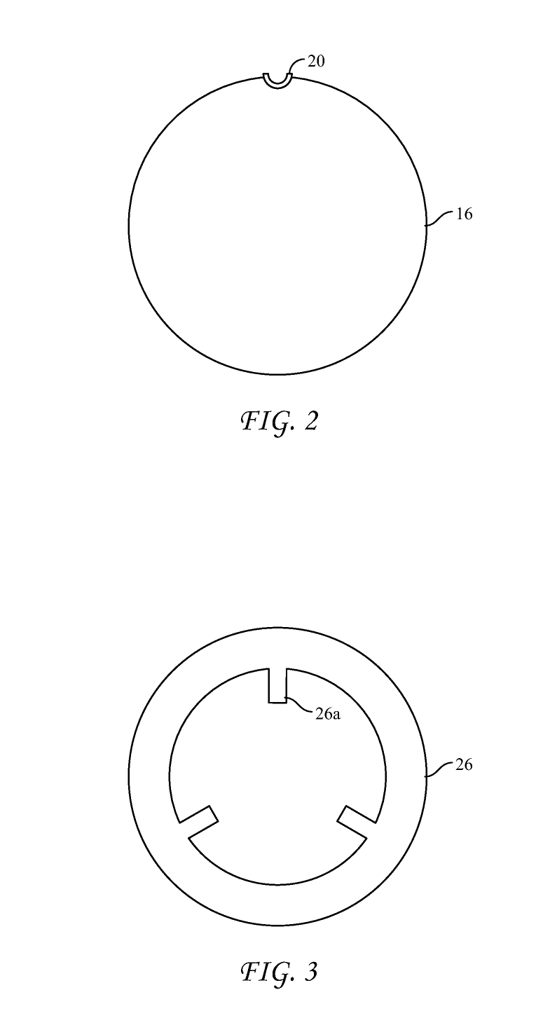

An alcohol evaporation consumption device, or device 10, is illustrated in FIG. 1. The device 10 may include a heating chamber 12. The heating chamber 12 may be a standard in glass, sized to support a heating element 14, such as a candle.

The device 10 may further include a vessel 16, such as a glass sphere. The vessel 16 is adapted to receive an alcoholic beverage 18 in liquid form.

The vessel may include an aperture 20. The aperture 20 may permit adding the liquid alcohol 18, such as with the assistance of a funnel 22. The aperture 20 may also permit insertion of a straw 24, such as a glass straw

The device 10 may also include a ring 26, having spaced tabs 26a (see FIG. 3) to better support the vessel 16 over the heating chamber 12, as well as to provide a vent to allow air to enter the heating chamber 12 to keep the candle 14 burning. Other vents may be provided in the heating chamber 12, to also permit air to enter the heating chamber 12.

In order to utilize the device 10, one may first place the candle 14 in the bottom of the heating chamber 12, such as a standard pint glass, and then light the candle 14. Then one may place the metal ring 26 on the top of the heating chamber 12, making sure that it is secure. Then one may place the vessel 16 on top of the ring 26 with the aperture 20 facing generally upwards. One may then place the funnel 22 into the opening of the vessel 16 and add 1-1.5 ounces of liquor to the vessel 16. Liquor with a proof of 80-100 works best, although others may be used,

One may then allow the liquor to heat for approximately 4-5 minutes. A clear vapor will begin to appear. One may the insert the straw 24 into the opening of the vessel 16, making sure it is above the liquid 18.

One may then inhale deeply, holding the vapors for a few seconds and exhaling. Only the vapors should be consumed.

While specific embodiments have been illustrated and described, numerous modifications may come to mind without significantly departing from the spirit of the invention, and the scope of protection is only limited by the scope of the accompanying claims.

1. An alcohol evaporation consumption device comprising:
a heating chamber;
a vessel disposed above the heating chamber, the vessel including an aperture, the aperture adapted to receive alcohol in liquid form to be placed in the vessel an to receive a straw; and
a heating element disposed in the heating chamber;
wherein the heating element heats the liquid alcohol in the vessel, converting the liquid alcohol into vapor, to be inhaled via the straw.

2. The device of claim 1, wherein the heating element comprises a candle.

3. The device of claim wherein a vent is provided to permit air to enter the heating chamber to permit the candle to continue burning.

4. The device of claim 3, wherein the vent comprises a ring disposed between the heating chamber and the vessel.

5. The device of claim 4, wherein the ring includes a plurality of spaced, inwardly projecting tabs.

6. The combination of a vessel with an opening to which liquor is added, the vessel held above a heat source by a base allowing for the heating of the liquor at a temperature that allows for the evaporation of alcohol from said liquor, resulting in a vapor consumed through the opening.

7. The combination of claim 6, including a straw inserted through the opening to permit consuming of the vapor.

8. A method of consuming evaporated alcohol comprising:
providing a heating element in a heating chamber;
providing vessel on top of the heating chamber, the vessel including an aperture;
providing alcohol in liquid form in the vessel via the aperture;
heating the alcohol for a period of time to vaporize the liquid alcohol; and
inhaling the vaporized alcohol via the aperture.

9. The method of claim 8, wherein the heating element is a candle.

10. The method of claim 9 including providing a ring between the heating chamber and the vessel to permit air to enter the heating chamber.
